(19) United States
(12) Patent Application Publication
(10) Pub. No.: US 2017/0082016 A1
(43) Pub. Date: Mar. 23, 2017

(54) TURBOCHARGER WITH A WASTE GATE VALVE

(71) Applicant: PIERBURG GMBH, NEUSS (DE)

(72) Inventors: MARTIN NOWAK, LEVERKUSEN (DE); MICHAEL-THOMAS BENRA, CASTROP-RAUXEL (DE); SVEN NIGRIN, DUESSELDORF (DE); STEPHAN ZIELBERG, BOCHUM (DE)

(73) Assignee: PIERBURG GMBH, NEUSS (DE)

(21) Appl. No.: 15/309,205

(22) PCT Filed: Feb. 19, 2015
(86) PCT No.: PCT/EP2015/053499

§ 371 Date: Nov. 7, 2016

(30) Foreign Application Priority Data
May 9, 2014 (DE) 10 2014 106 515.8

(51) Int. Cl. F02B 37/18; F02B 39/00; F01D 5/04; F01D 25/24; F02B 33/40; F04D 25/04

(52) U.S. Cl. CPC F02B 37/186; F02B 33/40; F04D 25/045; F01D 5/04; F01D 25/24; F02B 39/005; F05D 2220/40

(57) ABSTRACT

A turbocharger includes a waste gate valve, a compressor with a turbine, a turbine housing which houses the turbine, a bypass channel with an opening cross-section, a bypass channel portion formed in the turbine housing, an actuator housing with a separate coolant channel, an electric motor arranged in the actuator housing, a transmission with an output shaft, the transmission being arranged in the actuator housing and being provided as a worm wheel gear unit, and a control body coupled to the output shaft of the transmission. The bypass channel bypasses the turbine. The actuator housing is removably secured to the turbine housing. The control body controls the opening cross-section of the bypass channel.

### CROSS REFERENCE TO PRIOR APPLICATIONS

This application is a U.S. National Phase application under 35 U.S.C. §371 of International Application No. PCT/EP2015/053499, filed on Feb. 19, 2015 and which claims benefit to German Patent Application No. 10 2014 106 515.8, filed on May 9, 2014. The International Application was published in German on Nov. 12, 2015 as WO 2015/169461 A1 under PCT Article 21(2).

### FIELD

The present invention relates to a turbocharger with a waste gate valve, a compressor, a turbine, a turbine housing, a bypass channel for bypassing the turbine, a bypass channel portion which is formed in the turbine housing, an actuator housing, an electric motor which is arranged in the actuator housing, a transmission which is arranged in the actuator housing, an output shaft of the transmission, and a regulating element which is coupled to the output shaft and controls an opening cross-section of the bypass channel.

### BACKGROUND

Turbochargers with waste gate valves have previously been described. A turbocharger serves to increase the boost pressure and thus to increase the power of the internal combustion engine. The pressure which can be generated is always a function of the exhaust gas quantity conveyed due to the turbine wheel being coupled with the compressor wheel. It is therefore necessary to reduce or control the drive power acting on the compressor under certain operating conditions.

Waste gate valves are used therefor, among others, which valves are arranged in a bypass channel via which the turbine can be bypassed so that the turbine wheel is no longer acted upon by the entire flow quantity of the exhaust gas. These waste gate valves are most often designed as flap valves operated by a pneumatic actuator which drives a linkage coupled with the flap.

Since a high thermal load exists in the region of the turbine housing due to hot exhaust gases, these pneumatic actuators have been arranged in the region of the compressor, and in particular at a distance from the turbine housing, in order to reduce thermal load.

An exact control of the exhaust gas quantity discharged via the bypass channel is, however, difficult to achieve with a pneumatic actuator. Electric motors have therefore seen widespread use as drives for waste gate valves in recent years. These were typically also arranged at a distance from the turbine housing to reduce thermal load so that linkages were still used for coupling with the flap.

Because of ever decreasing available installation space, it is desirable to arrange the actuators of the waste gate valves in the immediate proximity to the valve itself since the installation space necessary is thus reduced and a more precise control becomes possible. When linkages are used, an increased wear of the mechanical components, in particular due to increased transverse forces in the region of the flap bearings, as well as increased assembly efforts, often also occur.

WO 2012/089459 A1 therefore describes a turbocharger with a water-cooled turbine housing and an integrated electric waste gate valve. The housing in which the electric motor for driving the waste gate valve and the transmission are arranged is a part of the turbine housing in which corresponding cooling channels are formed to carry water. The electric motor and the transmission are thus mounted on the turbine housing, wherein the necessary opening in the turbine housing is closed with a cover. The bearing of the valve is also arranged in the turbine housing.

The use of the above waste gate valve arrangement still risks a thermal overload of the actuator since the cooling medium is strongly heated while flowing through the turbine housing and is therefore not immediately effective at the actuator. The actuator is also subjected to a direct thermal radiation from outside so that, under unfavorable conditions, a risk of overheating still exists.

The arrangement of the electric motor directly in the turbine housing generally leads to thermal overload. A relatively large installation space is also required in the axial direction of the output shaft despite the integration of the actuator into the turbine housing.

### SUMMARY

An aspect of the present invention is to provide a turbocharger having a waste gate valve which reliably avoids a thermal overload of the actuator drive. Another aspect of the present invention is that the waste gate valve is easy to assemble, requires an installation space which is as small as possible, and has the greatest possible controllability exactness.

In an embodiment, the present invention provides a turbocharger which comprises a waste gate valve, a compressor comprising a turbine, a turbine housing configured to house the turbine, a bypass channel comprising an opening cross-section, a bypass channel portion formed in the turbine housing, an actuator housing comprising a separate coolant channel, an electric motor arranged in the actuator housing, a transmission comprising an output shaft, the transmission being arranged in the actuator housing and being provided as a worm wheel gear unit, and a control body coupled to the output shaft of the transmission. The bypass channel is configured to bypass the turbine. The actuator housing is removably secured to the turbine housing. The control body is configured to control the opening cross-section of the bypass channel.

### BRIEF DESCRIPTION OF THE DRAWINGS

The present invention is described in greater detail below on the basis of embodiments and of the drawings in which:

FIG. 1 is a side view of a turbocharger of the present invention with a waste gate valve in perspective view;

FIG. 2 is an exploded perspective side view of an actuator housing of the waste gate valve in FIG. 1; and

FIG. 3 is a sectional side view of the actuator housing of the waste gate valve in FIG. 1.

### DETAILED DESCRIPTION

Due to the fact that the actuator housing is detachably fastened on the turbine housing and has a separate coolant channel, with the transmission being a worm wheel gear unit, a separated coolant supply to the actuator is provided so that the supply can be effected in depending on the temperature actually prevailing in the actuator housing and independent of the temperature in the turbine housing. The effect of the heat radiation from the turbine is significantly reduced since the actuator housing is cooled directly. A thermal separation from the turbine housing is achieved that significantly reduces the heat transfer into the actuator housing. The advantage of a direct flap drive nevertheless exists by which a very precise control of the waste gate valve becomes possible. Manufacture and assembly of the actuator is simple even though the coolant channel is formed in the actuator housing since only a few components must be used. The installation space used in the axial direction of the output shaft is significantly reduced. The electric motor may thus be arranged at a certain distance from the turbine housing and under a lower resulting thermal load without increasing the axial height of the installation space.

In an embodiment of the present invention, the center axis of the input shaft of the electric motor can, for example, extend substantially vertically with respect to the output shaft so that a minimal structural height is obtained in the direction of the output shaft. Good accessibility of the actuator and its components is additionally provided even in the mounted state.

In an embodiment of the present invention, a first coolant channel section can, for example, circumferentially surround the transmission and be closed axially with an actuator cover. Great amounts of heat may thus be dissipated from the actuator. The bearing region of the output shaft is well cooled so that the service life of the bearings is extended. An introduction of heat from outside by thermal radiation is also reliably prevented.

To achieve a particularly good cooling of the thermally sensitive electric motor and, correspondingly, to dissipate sufficient heat, a second coolant channel section encloses the electric motor radially, at least in part, over the entire axial height and is closed with a motor cover. The heat from the electric motor can thus be guided to the outside and a thermal separation is provided from the possibly hot surroundings of the actuator. Thermal overload can thus be reliably avoided. The coolant channel can be formed in a die-casting process using a slide gate so that no lost cores must be used. Manufacturing costs are thereby reduced.

In an embodiment of the present invention, the first coolant channel section and the second coolant channel section can, for example, be connected with each other via two passage openings. Both coolant channels sections have a common through-flow so that additional conduits may be omitted. Assembly is thereby simplified and the installation space used is reduced.

In an embodiment of the present invention, a partition wall is advantageously formed in the first coolant channel section which is arranged between the two passage openings to the second coolant channel section. A forced flow around the transmission and thus around the bearing of the output shaft is obtained thereby.

In an embodiment of the present invention, a coolant inlet port and a coolant outlet port can, for example, be formed on the actuator housing in a receiving portion of the electric motor. An independent cooling circuit for the waste gate actuator can be connected via these ports so that an exact temperature control is possible.

In an embodiment of the present invention, a partition wall can, for example, be arranged in the second coolant channel section between the coolant inlet port and the coolant outlet port, the partition wall extending in the axial direction of the input shaft of the electric motor. A short circuit flow from the inlet port to the outlet port is thereby prevented. A forced flow around the entire transmission and the electric motor, and thus a cooling over the entire circumference, is instead provided.

In an embodiment of the present invention, electronic components of the waste gate valve can, for example, be arranged on the actuator cover so that additional components to be mounted which receive the electronics can be omitted. This additionally facilitates assembly.

In an embodiment of the present invention, a connector and a contactless sensor for position feedback can, for example, be fastened on the actuator cover, the sensor communicating with a magnet connected with the output shaft. An otherwise necessary sealing of a connector passage is thereby omitted. The actuator cover can be formed integrally with the necessary lines by an injection molding. Assembly steps are thus omitted that would otherwise be necessary for assembling the electronics into the housing. The magnet is fastened either directly on the output shaft or indirectly on a component connected for rotation with the output shaft, such as the output gear. A position detection is thus performed at the output shaft itself so that errors caused by inaccuracies at the transmission are excluded.

Further simplification is achieved if the terminals for the electric motor are formed on the actuator cover so that an electric contacting of the electric motor is effected automatically when affixing the cover. All live lines can thus be formed on the cover or be molded therein. A simplification of the assembly and the manufacture of the actuator is thereby achieved.

The output shaft is connected with a flap shaft, in particular via an Oldham coupling, a control body being fastened to the flap shaft, whereby a good controllability with a simultaneous thermal separation or isolation is achieved in order to reduce the heat transported into the actuator via the shaft. This coupling also can be made from a material with poor thermal conductivity, such as ceramics. This coupling also serves as a tolerance compensation element between the flap shaft and the output shaft.

A turbocharger with a waste gate valve is accordingly provided that is reliably protected from thermal overload and which may be mounted to the turbocharger as a preassembled component so that assembly is facilitated, while making a very precise control of the waste gate valve possible. The cooling can be separately adapted to the requirements of the turbine and the valve. The necessary installation space is significantly reduced compared to known designs.

An embodiment of a turbocharger of the present invention with a waste gate valve is illustrated in the drawings and will be described hereunder.

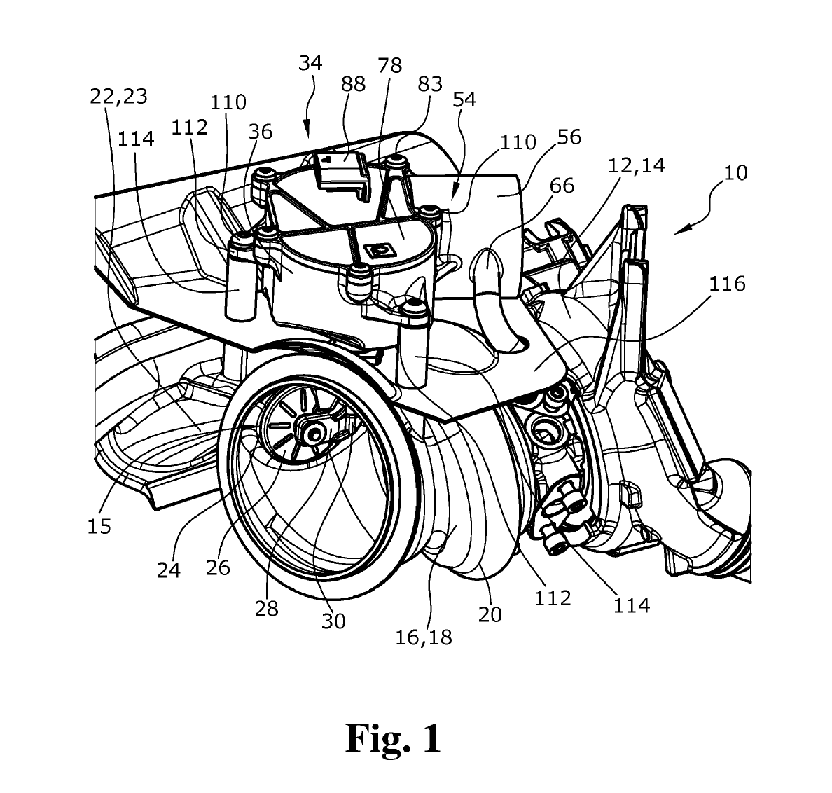

The turbocharger 10 illustrated in FIG. 1 comprises a compressor 12 with a compressor wheel arranged in a compressor housing 14, and a turbine 16 with a turbine wheel arranged in a turbine housing 18. The turbine wheel is fastened in a manner known per se on a common shaft with the compressor wheel so that the movement of the turbine wheel caused by an exhaust gas flow in the turbine housing 18 is transmitted to the compressor wheel via the shaft, whereby an airflow is compressed in the compressor housing 14.

A bypass channel 22 in which a waste gate valve 15 is arranged branches off upstream of the spiral channel 20 surrounding the turbine wheel in the turbine housing 18. This bypass channel 22 opens into the subsequent exhaust gas channel of the internal combustion engine behind the spiral channel 20.

A valve seat 24 of the waste gate valve 15 that surrounds an opening cross section of the bypass channel 22 is situated in a bypass channel section 23 formed in the turbine housing 18. The opening cross section is controllable via a control body 26 in the form of a flap, which may be placed on the valve seat 24 to close the opening cross section and which may be lifted off the valve seat 24 to open the flow cross section of the bypass channel 22.

The control body 26 is fastened to a lever 28 that extends from a flap shaft 30 and is integrally formed therewith for this purpose. The flap shaft 30 has the same axis of rotation as the output shaft/drive shaft 32 of an actuator 34 via which the control body 26 is operated. The output shaft 32 thereby extends out of an actuator housing 36 towards the turbine housing 18 and is connected for rotation with the flap shaft 30 by an Oldham coupling 38, with other couplings also being conceivable.

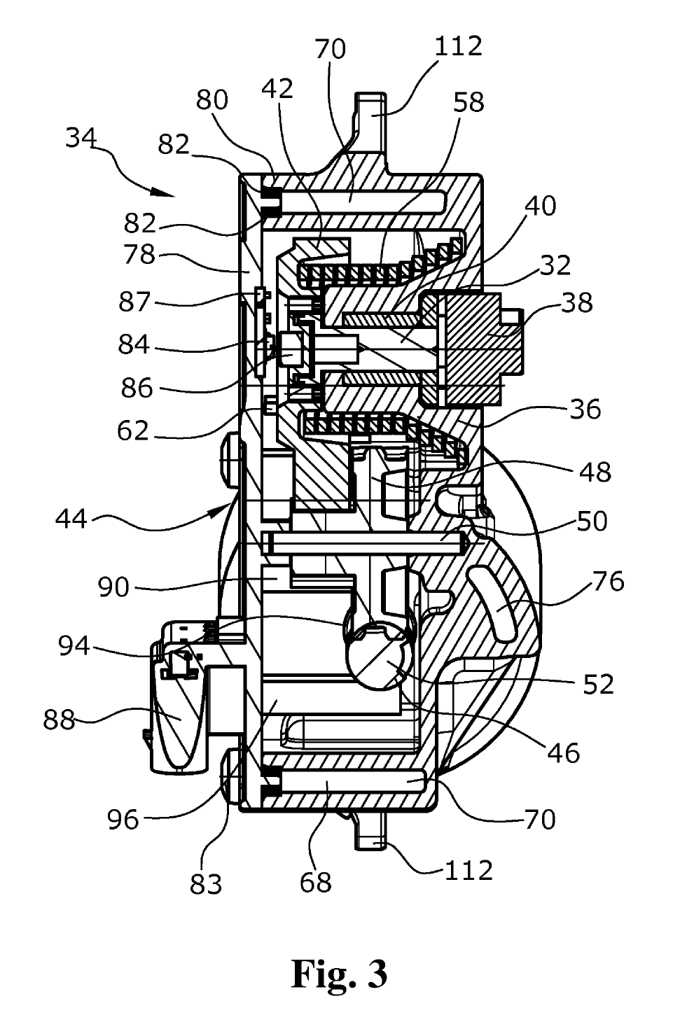

As can in particular be seen in FIG. 3, a bearing 40 supports the output shaft 32 in the actuator housing 36 which is formed as an integral die-cast part. An output gear 42 of a transmission 44, designed as a gear segment, is arranged on the output shaft 32, the transmission 44 being arranged inside the actuator housing 36 and being configured, according to the present invention, as a worm wheel gear unit. The worm wheel gear unit consists of a helical gear 46 serving as a drive gear which meshes with the larger gear of a double gear 48, whose smaller gear meshes with the output gear 42. The double gear 48 is supported on an axle 50 fastened in the actuator housing 36.

The helical gear 46 is arranged on an input shaft 52 of an electric motor 54 which serves as a drive. The electric motor 54 is arranged in a receiving space 56 of the actuator housing 36, the receiving space 56 extending vertically with respect to the output shaft 32.

A return spring 58 is additionally arranged in the actuator housing 36, which return spring 58 surrounds the output shaft 32 and a first end leg 60 of which rests on an abutment in the actuator housing 36, while the second end leg 62 engages into the output gear 42 so that, in the event of a failure of the electric motor 54 or other malfunction, the output shaft 32, and thus the control body 26, is rotated into a fail-safe position so as to avoid damage to the turbocharger 10 caused by exceeding the maximum permitted rotational speed.

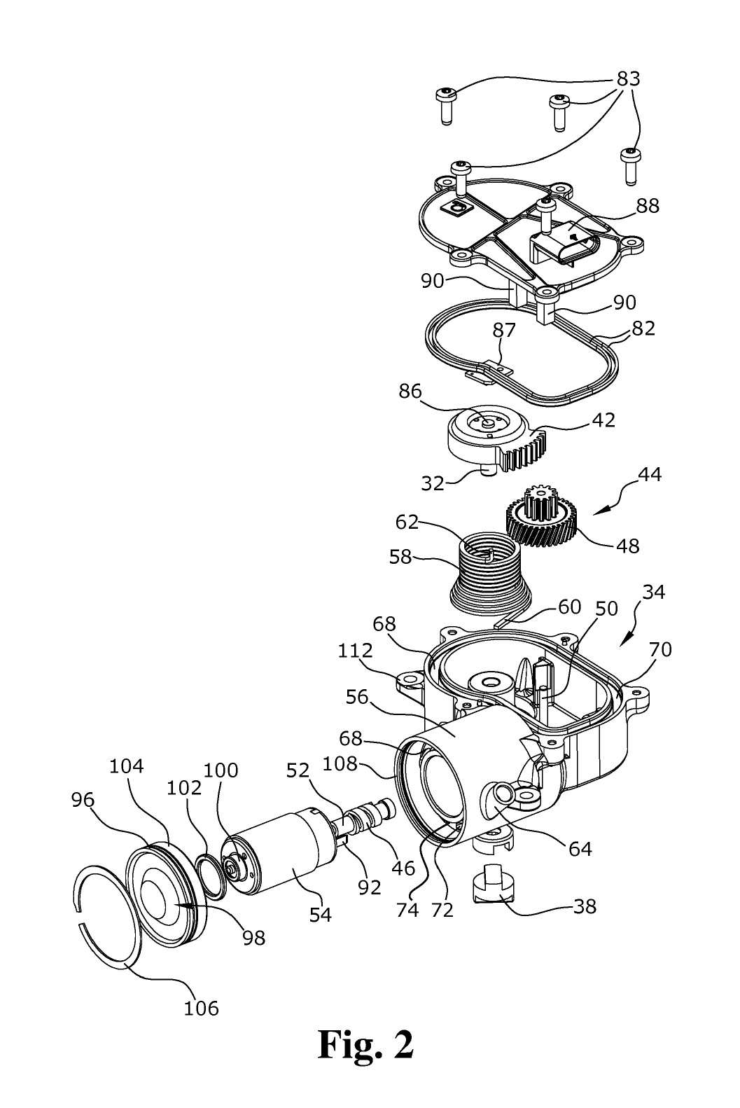

A coolant inlet port 64 and a coolant outlet port 66 are formed on the actuator housing 36 at the receiving space 56 of the electric motor 54, which are connected with a coolant channel 68 formed in the actuator housing 36. As can be seen in FIG. 2, this coolant channel 68 is formed by a first coolant channel section 70 surrounding transmission 44, as well as by a second coolant channel section 72 which extends all over the circumference of the electric motor 54, except for a partition wall 74 formed in the axial direction with respect to the input shaft 52 between the coolant inlet port 64 and the coolant outlet port 66. The partition wall 74 extends over the entire axial height of the electric motor 54 so that the coolant is forced to flow into the first coolant channel section 70 via a passage opening 76. Another partition wall is formed (not visible in the drawings) in the second coolant channel section 72 which extends over the axial height parallel to the output shaft 32 of the second coolant channel section. This partition wall is situated in the region of the actuator housing 36 surrounding the transmission 44, which region adjoins the receiving space 56 of the electric motor 54, whereby the coolant is forced to flow around the transmission 44. After having flowed around the transmission 44, the coolant again flows through a second passage opening (not visible in the drawings) into the second coolant channel section 72 that surrounds the electric motor 54, but on the other side of the partition wall 74, in the direction of the coolant outlet port 66.

The first coolant channel section 70 and the interior of the actuator housing 36 is closed by an actuator cover 78. This actuator cover 78 is in particular manufactured by a plastics injection molding. For a tight closure of the coolant channel 68, a circumferential projection 80 is formed on the actuator cover 78 on the side facing the actuator housing 36, the projection 80 corresponding to the shape of the first coolant channel section 70 and having the width thereof so that the projection 80 protrudes into the recess in the actuator housing 36 serving as the first coolant channel section 70. On its opposite sides, seen in cross section, a respective seal 82 is formed extending circumferentially with the projection, the seal 82 providing a tight closure of the first coolant channel section 70.

Besides its function as a closure for the actuator housing 36, the actuator cover 78, which is fastened to the actuator housing 36 by screws 83, also serves as a carrier for electric components of the actuator 34. The side of the actuator cover 78 directed towards the interior of the actuator 34 is accordingly provided with a Hall sensor 84 for position feedback, the sensor communicating with a magnet 86 arranged on the end of the output shaft 32. A circuit board 87, which may include control elements of the actuator 34 and on which the Hall sensor 84 is arranged, is further formed on this side of the actuator cover 78. The circuit board 87 and the Hall sensor 84 are connected with a connector 88 via invisible lines molded in the actuator cover 78, the connector being made integrally with the actuator cover 78 and extending outward. Two projections 90 extend towards the electric motor 54 on the side of the actuator cover 78 opposite the connector 88 in which terminals are formed via which the contact tabs 92 of the electric motor 54 are connected for power supply to the electric motor 54.

As can be seen in FIG. 2, the electric motor 54 is pushed vertically with respect to the axis of the output shaft 32 from outside into the receiving space 56 against an abutment of the actuator housing 36. This abutment has an opening for receiving the A-bearing 94 of the electric motor 54 through which the helical gear 46 protrudes into the portion of the actuator housing 36 surrounded by the first coolant channel section 70. Two openings are further formed in the region of the abutment through which the contact tabs 92 of the electric motor 54 extend into the two projections 90 of the actuator cover 78.

On the side axially opposite the actuator cover 78, the receiving space 56 of the electric motor 54 is closed with a motor cover 96 that simultaneously closes the second coolant channel section 72. This motor cover 96 has a recess 98 for receiving a B-bearing 100 of the electric motor 54 as well as an invisible axial groove into which a corrugated spring 102 is placed to clamp the electric motor 54 in the axial direction. Similar to the actuator cover 78, the motor cover 96 is further formed with a circumferential projection 104 with, seen in cross section, opposite ring seals, the projection 104 extending into the cooling channel section 72 and sealing the cooling channel section 72 to the outside. The motor cover 96 is fastened by a clamping ring 106 which, in the assembled state, is retained in a radial groove 108 at the axial end of the receiving space 56 of the actuating housing 36.

The actuator 34 is fastened to the turbine housing 18 by screws 110 inserted through eyelets 112 formed at the sides of the actuator housing 36 and threaded into domes 114 with female threads formed on the turbine housing 18. A heat dissipation sheet 116 is provided between the actuator 34 and the turbine housing 18 for an additional shielding of the actuator housing 36 from heat radiation.

The described waste gate valve requires little installation space, in particular in the axial direction. It also has its own cooling circuit that makes it possible to control the temperature in the housing of the waste gate valve separately, i.e., independent of the turbine housing of the turbocharger. The actuator of the waste gate valve may be preassembled and thereafter be mounted on the turbine housing so that a direct connection of the actuator to the valve is obtained, whereby a precise control becomes possible. A long service life is achieved due to the good thermal decoupling of the actuator from the turbine housing and, as a consequence thereof, the low thermal load on the electric motor and on the other electronic components. Assembly is greatly simplified since all electronic components are formed on the actuator cover and are thus mounted together with the actuator cover which at the same time closes the coolant channel. The number of components that are present and which must be mounted is thereby reduced.

It should be clear that the present invention is not restricted to the shown embodiment, but that various modifications are possible which fall within the scope of protection of the main claim. It is in particular possible to fasten the covers in a different manner or to use axial seals. It is also conceivable to use a continuous shaft with poor thermal conductivity. Reference should also be had to the appended claims.

What is claimed is:

1-12. (canceled)

13: A turbocharger comprising:
a waste gate valve;
a compressor comprising a turbine;
a turbine housing configured to house the turbine;
a bypass channel comprising an opening cross-section, the bypass channel being configured to bypass the turbine;
a bypass channel portion formed in the turbine housing;
an actuator housing comprising a separate coolant channel, the actuator housing being removably secured to the turbine housing;
an electric motor arranged in the actuator housing;
a transmission comprising an output shaft, the transmission being arranged in the actuator housing and being provided as a worm wheel gear unit; and
a control body coupled to the output shaft of the transmission, the control body being configured to control the opening cross-section of the bypass channel.

14: The turbocharger as recited in claim 13, wherein the electric motor comprises an input shaft which comprises a center axis which extends substantially vertically with respect to the output shaft of the transmission.

15: The turbocharger as recited in claim 14, further comprising:
a first coolant channel section configured to circumferentially surround the transmission; and
an actuator cover configured to axially close the first coolant channel section.

16: The turbocharger as recited in claim 15, further comprising:
a second coolant channel section configured to radially enclose the electric motor at least in part over an entire axial height; and
a motor cover configured to close the second coolant channel section.

17: The turbocharger as recited in claim 16, further comprising two passage openings configured to connect the first coolant channel section and the second coolant channel section with each other.

18: The turbocharger as recited in claim 17, further comprising a first partition wall formed in the first coolant channel section between the two passage openings to the second coolant channel section.

19: The turbocharger as recited in claim 18, wherein,
the electric motor comprises a receiving portion, and
further comprising a coolant inlet port and a coolant outlet port formed on the actuator housing in the receiving portion of the electric motor.

20: The turbocharger as recited in claim 19, further comprising a second partition wall arranged in the second coolant channel section between the coolant inlet port and the coolant outlet port, the partition wall being configured to extend in an axial direction of the input shaft of the electric motor.

21: The turbocharger as recited in claim 15, wherein the waste gate valve comprises electronic components which are arranged on the actuator cover.

22: The turbocharger as recited in claim 21, further comprising:
a magnet connected with the output shaft of the transmission,
wherein, the electric components include a connector and a contactless sensor which are configured to provide a position feedback, the sensor being configured to communicate with the magnet.

23: The turbocharger as recited in claim 15, further comprising terminals for the electric motor formed on the actuator cover.
